(19) United States
(12) Patent Application Publication
(10) Pub. No.: US 2016/0089812 A1
(43) Pub. Date: Mar. 31, 2016

(54) Saw Blade For Making Thin Cuts in Green Concrete

(71) Applicant: Husqvarna AB, Huskvarna (SE)

(72) Inventors: Rodger Lagow, Blythewood, SC (US); Jon Fleetwood, Blythewood, SC (US)

(21) Appl. No.: 14/499,988

(22) Filed: Sep. 29, 2014

(51) Int. Cl. B28D 1/12; B23D 61/02; B28D 1/04

(52) U.S. Cl. CPC B28D 1/121; B28D 1/04; B23D 61/026

(57) ABSTRACT

A saw blade for rotating about an axis to cut green concrete may include a main body and a cutting portion. The main body includes an inner section and an outer section. The inner section has a first thickness in an axial direction that is greater than a second thickness of the outer section. The cutting portion includes a diamond-metal matrix joined to the outer section to cut a material responsive to rotation of the blade. The inner section extends radially outwardly from a center of the blade to a non-contact shoulder at the first thickness to transition to the outer section at the second thickness. The outer section extending radially outwardly to an outer diameter of the main body.

### TECHNICAL FIELD

Example embodiments relate to a saw that is appropriate for cutting control joints in green concrete, and more particularly relate to a saw having a diamond blade with a thicker core and thin cutting portion with a non-contact shoulder forming a portion of the transition between thicknesses.

### BACKGROUND OF THE INVENTION

Concrete is typically formed in a flowing state to enable the concrete to be evenly spread over a surface. The concrete can then be worked and/or finished before hardening. After finishing, the concrete is generally allowed to cure or set to transition into a characteristically hard state.

During curing or setting, the concrete tends to shrink while hardening. In the absence of any crack prevention efforts, the shrinking process would undoubtedly generate cracks at various locations throughout the concrete. These cracks are unsightly, but can also lead to accelerated degradation of the concrete.

To prevent or at least inhibit the generation of cracks in undesirable locations, and to improve the general appearance and quality of the finished product, it is common practice to cut control joints in the concrete so that the cracks that form will occur at controlled locations where the control joints have been cut.

The cutting of control joints is typically performed with a saw assembly having a special blade for cutting green concrete. In the past, the thickness of the blade has typically been between about 2.4 mm to about 3.2 mm. However, more and more large industrial floor projects are specifying thinner control joint widths of, for example, 1.6 mm to about 2 mm. The provision of thin blades for making such cuts has generally compromised the cutting speed and the lifespan of the thin blades used to make such cuts due to the lack of rigidity of the thin core.

Thus, improvements in blade design may be warranted.

### BRIEF DISCLOSURE OF THE INVENTION

To provide a saw blade that is capable of making thin cuts of approximately 2 mm or less for control joints in green concrete at a high speed, some example embodiments may employ a non-contact shoulder to provide a transition between a thicker core and a thinner cutting portion. The thicker core may provide the stability necessary to allow the blade to be operated at relatively high speed, and the non-contact shoulder may provide a transition to the thinner cutting portion so that the desirable thin cut can be achieved. Moreover, the thinner cutting portion may be displaced from the non-contact shoulder by sufficient distance to ensure that the non-contact shoulder does not come into contact with the concrete. To achieve this, a portion of the main body that forms the core may be extended beyond the non-contact shoulder to place the thinner cutting portion far enough from the non-contact shoulder that the desired cutting depth can be achieved without bringing the non-contact shoulder into contact with the concrete.

In accordance with an example embodiment, a saw blade for rotating about an axis to cut concrete is provided. The blade may include a main body and a cutting portion. The main body may include an inner section and an outer section. The inner section may have a first thickness in an axial direction that is greater than a second thickness of the outer section. The cutting portion may include a diamond-metal matrix joined to the outer section to cut a material responsive to rotation of the blade. The inner section may extend radially outwardly from a center of the blade to a non-contact shoulder at the first thickness to transition to the outer section at the second thickness. The outer section may extend radially outwardly to an outer diameter of the main body.

In accordance with another example embodiment, a saw assembly may be provided where the saw assembly employs a blade of an example embodiment.

### BRIEF DESCRIPTION OF THE DRAWINGS

In the following description of preferred embodiments, reference will be made to the accompanying drawings, in which,

FIG. 1 shows a view of a control joint that is cut in green concrete to avoid random cracks from forming in the concrete

FIG. 2 shows a perspective view of mobile saw employing a blade of an example embodiment;

FIG. 3 shows a top view of a saw blade in accordance with an example embodiment;

FIG. 4 illustrates a cross section view of the blade in accordance with an example embodiment;

FIG. 5 shows a close-up view of a portion of the cross section view of FIG. 4 in which the main body of the blade is integrally formed from a single unitary piece of material in accordance with an example embodiment; and

FIG. 6 shows a close-up view of a portion of the cross section view of an alternative blade structure in which the main body of the blade is formed by joining multiple pieces of material in accordance with an example embodiment.

### DESCRIPTION OF PREFERRED EMBODIMENTS

The present invention will be described more fully hereinafter with reference to the accompanying drawings, in which example embodiments of the invention incorporating one or more aspects of the present invention are shown. In the drawings, like numbers refer to like elements.

For a typical 12 inch blade, the thinnest steel core that can typically be purchased is about 1.5 mm. The cutting portion of such a blade may be expected to be formed of one or more cutting segments that are made of a diamond-metal matrix. The cutting portion may be laser welded onto the steel core, and may have a thickness of about 2 mm. Thus, in cross section, the cutting portion may form a T shape relative to the steel core and the cutting portion may engage the aggregate to cut the aggregate responsive to operation of the saw blade.

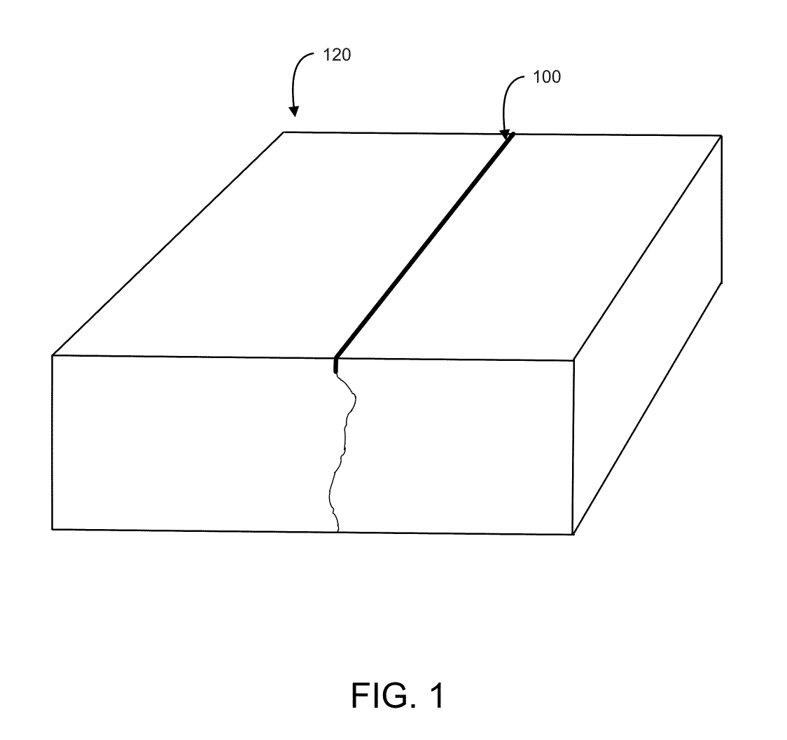

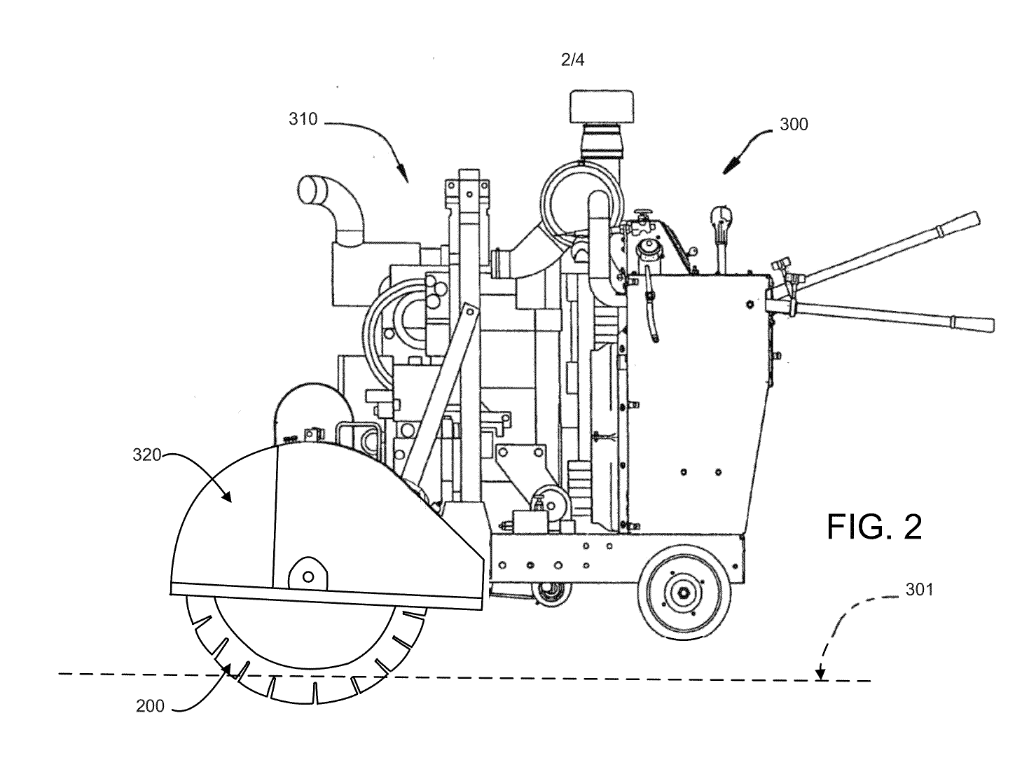

When the steel core is rotated at high speeds, stability problems may be encountered. Thus, saw blades such as the one described above must be operated at lower speeds when under load. These blades have also experienced shorter usable lifetimes. As mentioned above, some example embodiments may provide operators with the ability to provide thin cuts when cutting control joints as previously described (See FIG. 1) while still operating the saw blade at a relatively high speed. As shown in FIG. 1, a control joint 100 may be cut in a slab 120 of green concrete to ensure that crack propagation is not random in the slab 120. FIGS. 2-6 show various views of portions of saws and corresponding blades that employ example embodiments from different perspectives in order to facilitate description of some example embodiments.

FIG. 2 shows an example of a saw that may employ blades of an example embodiment. In this regard, FIG. 2 illustrates a mobile saw assembly that may be transported on wheels or some other type of mobility assembly rather than being carried. The blade 200 may also or alternatively be employed on floor saws, road saws, wall saws, flat saws, early entry saws, span saws and or the like that may be similarly utilized for cutting thin control joints in green concrete. Thus, for example, tracks may be bolted onto a floor or wall or fully span the concrete with supports holding the track over the concrete, and saws employing example embodiments may be attached to a mobility assembly that runs along the tracks. Alternatively, the mobility assembly could include wheels (e.g., at least three wheels) that ride over the concrete surface.

FIG. 2 illustrates an example of a mobile saw 300 that may have a mobility assembly in addition to the motor 310 that rotatably drives the blade 200. The mobility assembly may carry the mobile saw 300 over a surface 301. The motor 310 may be a hydraulic, pneumatic, electric, battery-electric, or internal combustion engine. The blade 200 may be at least partially enclosed within blade guard 320. The saw 300 of FIG. 2 may employ the blade 200 of an example embodiment for either dry or wet cutting of green concrete. Thus, for example, the saw 300 of example embodiments may be typically expected to make crack control joints in concrete that had been poured between 2 and 48 hours prior to the cutting (See FIG. 1).

As shown in FIG. 2, the saw 300 may include the blade 200 of an example embodiment. Moreover, as described above, the blade 200 may be constructed to have a relatively thicker main body section separated from a thinner cutting section. By providing the thicker main body section, the blade 200 may generally be more stable at higher speeds. Accordingly, the blade 200 may be enabled to cut green concrete with relatively thin crack control joints (e.g., less than 2 mm wide) without necessarily sacrificing speed.

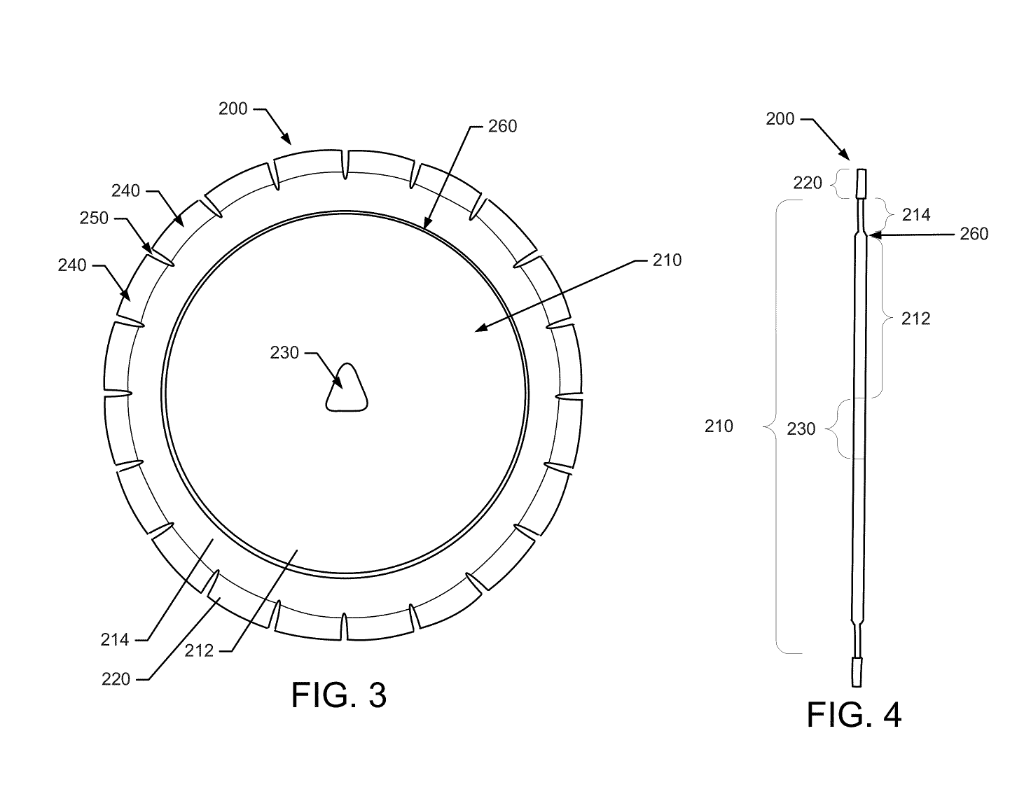

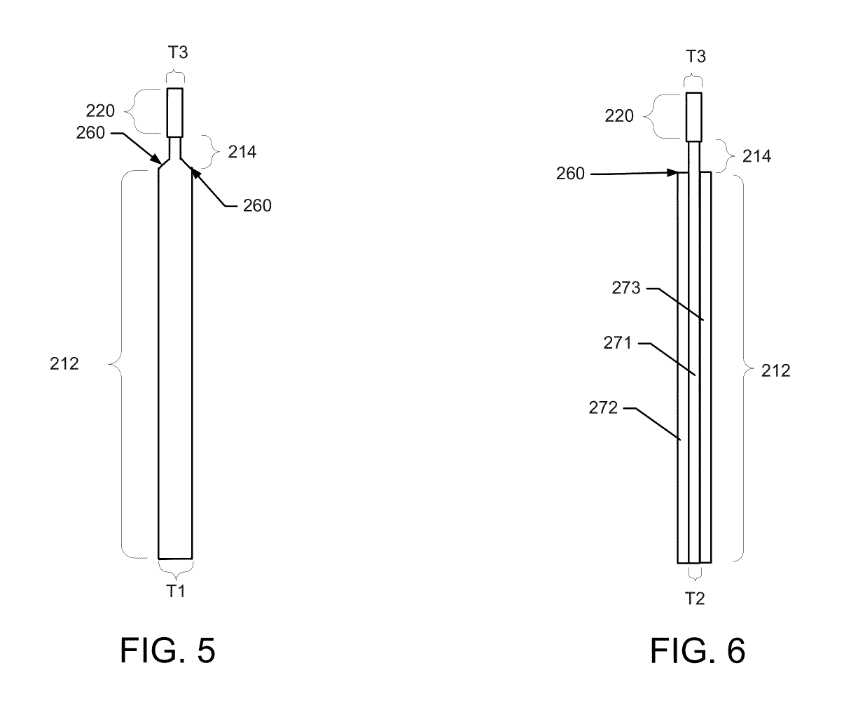

To accomplish the transition from the thicker main body portion to the thinner cutting section, example embodiments may employ a non-contact (or contact-less) shoulder portion that is configured to make the thickness transition, but never contact the material or surface being cut. FIG. 3 illustrates a top (or bottom) view of the blade 200 of an example embodiment. The view of FIG. 3 is from a perspective that is looking down the axis of the blade 200. Meanwhile, FIG. 4 illustrates a cross section view of a portion of the blade 200 where the cross section is cut through the axis. FIG. 5 illustrates a cross section view of only a top portion of the blade 200 of FIG. 4. Meanwhile, FIG. 6 illustrates a cross section view of an alternative construction of the blade 200 according to an example embodiment.

As shown in FIGS. 3 and 4, the blade 200 may include a main body 210 and a cutting portion 220. The main body 210 may be further sub-divided into an inner section 212 and an outer section 214. The inner section 212 may extend radially outwardly from an arbor 230 of the blade 200 to the outer section 214. The outer section 214 may be coaxial with the inner section 214 and may be formed around the external periphery of the inner section 212. The arbor 230 may have any shape and may be configured to mate with a clamping device of the saw 300 to enable the blade 200 to be fixed in rotatable contact with the saw 300.

The cutting portion 220 may be formed from a diamond-metal matrix to give the cutting portion 220 an appropriate diamond-metal composition to enable it to cut green concrete. The cutting portion 220 may be joined to the outer section 214 such that the cutting portion 220 extends radially outwardly from the outer section 214 to cut material responsive to rotation of the blade 200. The joint therebetween may be provided by laser welding, spot welding, gluing, soldering or any other suitable method of adhesion. Although not required, the cutting portion 220 may be divided into segments 240 that may be divided from each other by slots 250. The slots 250 may extend radially inwardly from the outer edges of the blade 200 and may be used to carry material out of the groove being cut when the blade 200 is employed.

The slots 250 may have any suitable length. However, for a typical example of the blade 200, which may have a diameter of about 8 inches to about 18 inches, the slot 250 (if employed) may be expected to have a length of between about 1/16 inch to about ¾ inch. Although the cutting portion 220 could also have any suitable length including a length (in the radial direction) that is less than, equal to, or greater than the length of the slot 250, some example embodiments may employ a cutting portion length of about 1 inch to about 2 inches.

As shown in FIGS. 4-6, the inner section 212 may have a first thickness (T1) and the outer section 214 may have a second thickness (T2). The first thickness (T1) may be larger than the second thickness (T2). However, the inner section 212 and the outer section 214 may otherwise be entirely made of or include the same material. Thus, for example, both the inner section 212 and the outer section 214 may be made of steel or some other metal. In order to create the transition between the inner section 212 and the outer section 214, some example embodiments may provide a non-contact (or contact-less) shoulder 260. As such, for example, the inner section 212 may extend outwardly away from the arbor 230 of the blade 200 at the first thickness (T1) until the non-contact shoulder 260 is reached. At the non-contact shoulder 260, a transition in thickness of the blade 200 may be provided to reduce the thickness of the blade 200 to the second thickness (T2). The outer section 214 may then continue to extend from the non-contact shoulder 260 radially outwardly to the cutting portion 220.

In an example embodiment, the cutting portion 220 may have a third thickness (T3) that is approximately equal to or less than the first thickness (T1) and greater than the second thickness (T2). As such, the cutting portion 220 may essentially form somewhat of a T-shape relative to the outer section 214 and overhang each lateral side of the outer section 214 slightly. In some cases, the difference between the second thickness (T2) and the third thickness (T3) may be about ½ mm. However, larger or smaller differences could be employed in some other embodiments. Since, as stated above, the blade 200 of an example embodiment may be provided to allow thin cuts of between about 1.5 mm to about 2 mm, it can be appreciated that the third thickness (T3) may also be less than or equal to about 2 mm (e.g., about 1.3 to about 2.2 mm), and the second thickness (T2) may be less than about 1.8 mm. Meanwhile, the first thickness (T1) may be approximately equal to or substantially greater than the third thickness (T3). For example, the first thickness may be about 2 to 5 mm in some embodiments or more broadly can be in a range from about 2 to 20 mm. In some cases, the second thickness (T2) may be below 2.2 mm, below 2 mm, below 1.8 mm or below 1.6 mm.

The non-contact shoulder 260 may be formed by material disposed to extend from a surface of the inner section 212 to a surface of the outer section 214 at an angle. In some embodiments, the transition between the first and second thicknesses (T1 and T2), which is accomplished at the non-contact shoulder 260, may be made by tapering the sides of the blade 200 from the first thickness (T1) to the second thickness (T2). However, in some cases, the transition may be made instantaneously and without tapering. Thus, the angle formed between the outer section 214 and the inner section 212 may be equal to 90 degrees (as shown in FIG. 6) or may be substantially greater than or less than 90 degrees as well as shown in a typical example where the angle may be about 45 degrees (as shown in FIG. 5).

As can be appreciated from FIGS. 3 and 4, the diameter of the blade 200 may extend from the rotational axis of the blade 200 to the outer edge of the cutting portion 220. Meanwhile, the noncontact shoulder 260 may or may not be provided nearer to the cutting portion 220 than to the rotational axis of the blade 200 and will be approximately equal to or greater than the saw assembly flange diameter which is typically about ¼ of the blade diameter. As such, in some example embodiments, the length of the inner section 212 in the radial direction may be approximately twice the length of the outer section 214 and the cutting portion 220 in the radial direction combined. This arrangement may provide for the substantially thicker core portion of the blade 200 to extend closer to the cutting portion 220 to facilitate high speed operations with very thin cutting capabilities. In other embodiments, the non-contact shoulder may be approximately equal to or greater in diameter than the saw flange diameter which is often approximately ¼ of the blade diameter.

The non-contact shoulder 260 may, as the name suggests, be provided at a distance away from a distal edge (or periphery) of the cutting portion 220 that is greater than the cutting depth so that there is no contact between the non-contact shoulder 260 and the material being cut. Thus, for example, if the cutting depth is about 41 mm, then the non-contact shoulder 260 may be located at least about 45 mm or more from the distal edge of the cutting portion 220. In order to increase stability while still providing the ability to make high speed, thin cuts, the non-contact shoulder 260 may be provided relatively close to the cutting depth, but still provide a buffer to ensure that the non-contact shoulder 260 does not contact the material being cut. Because the non-contact shoulder 260 is not designed to contact the material being cut, the shape of the non-contact shoulder 260 is not a critical design feature and thus, there can be a great deal of flexibility offered relative to the shape to be employed for the non-contact shoulder 260.

As shown in FIG. 5, the outer section 214 may be thinner in thickness than the inner section 212 (and the cutting portion 220). Thus, in some cases, a piece of material (e.g., steel) may be etched or milled at opposing surfaces thereof to reduce the thickness of the material proximate to the periphery of the blade 200 to form the non-contact shoulder 260. As such, the outer section 214 and the inner section 212 may, in some cases, be integrally formed from a single piece of material forming the main body 210. However, in some alternative embodiments, it may be considered easier or more desirable to form the main body 210 from multiple pieces of material instead of from a single piece of material (as provided in FIG. 5). FIG. 6 illustrates such an example. In this regard, for example, a center hub 271 may be provided as a plate shaped piece of material having the second thickness (T2). The center hub 271 may extend the full length of the main body 210 (i.e., the full length diameter of the blade 200 except for the cutting portion 220). Then additional plates such as a first plate 272 and a second plate 273 may be provided on opposing sides of the center hub 271 to form the remainder of the main body 210. As can be appreciated from the description above, and from FIG. 6, the first and second plates 272 and 273 may only extend over the center hub 271, and thereby also combine with the corresponding portion of the center hub 271, to form the inner section 271. The center hub 271 may be joined to the first and second plates 272 and 273 by any suitable method including welding, gluing, soldering or other adhesive agents.

Based on the descriptions and drawings provided above, it should be appreciated that a saw blade for rotating about an axis to cut green concrete is provided herein. The blade may include a main body and a cutting portion. The main body may include an inner section and an outer section. The inner section may have a first thickness in an axial direction that is greater than a second thickness of the outer section. The cutting portion may include a diamond-metal matrix joined to the outer section to cut a material responsive to rotation of the blade. The inner section may extend radially outwardly from a center of the blade to a non-contact shoulder at the first thickness to transition to the outer section at the second thickness. The outer section may extend radially outwardly to an outer diameter of the main body.

The blade of some embodiments may include additional features that may be optionally added either alone or in combination with each other. For example, in some embodiments, (1) the inner section may be comprised of a steel core having the first thickness (T1) of about 2 mm to about 20 mm. In addition to (1) or as an alternative, in some embodiments, (2) the first thickness (T1) may be up to about ten times larger than the second thickness (T2). In addition to (1) and (2) or as an alternative, in some embodiments, (3) the second thickness (T2) may be less than about 2 mm.

In some embodiments, any or all of (1) to (3) may be employed in addition to the optional modifications or augmentations described below. For example, in some embodiments, the non-contact shoulder may be formed at a 90 degree angle relative to a face of the outer section, although other angles including, for example, 45 degrees, are also possible. Additionally or alternatively, the outer section and the inner section may be integrally formed from a same piece of material. As an alternative, the inner section may include a center hub that extends beyond the non-contact shoulder to form the outer section. The inner section may further include a first plate disposed on a first face of the center hub and a second plate disposed on an opposite face of the center hub. Each of the first and second plates may terminate at the non-contact shoulder. Additionally or alternatively, the cutting portion may have a third thickness (T3), and the third thickness (T3) may be greater than the second thickness (T2) and may be approximately equal to or less than the first thickness (T1). Additionally or alternatively, the non-contact shoulder may be separated from a distal end of the cutting portion by a distance greater than a cutting depth of the saw blade. Additionally or alternatively, the blade may further include slots extending radially inwardly from a periphery of the blade to separate the cutting portion into segments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A saw blade for rotating about an axis to cut thin control joints of about 2 mm or less in green concrete, the blade comprising:
a main body comprising an inner section and an outer section, the inner section having a first thickness in an axial direction that is greater than a second thickness of the outer section; and
a cutting portion comprising a diamond-metal matrix joined to the outer section to cut a material responsive to rotation of the blade,
wherein the inner section extends radially outwardly from a center of the blade to a non-contact shoulder at the first thickness to transition to the outer section at the second thickness, the outer section extending radially outwardly to an outer diameter of the main body.

2. The blade of claim 1, wherein the inner section comprises a steel core having the first thickness of about 2 mm to about 20 mm.

3. The blade of claim 1, wherein the first thickness is up to about ten times larger than the second thickness.

4. The blade of claim 1, wherein the second thickness is less than about 2 mm.

5. The blade of claim 1, wherein the non-contact shoulder is formed at a 90 degree angle relative to a face of the outer section.

6. The blade of claim 1, wherein the non-contact shoulder is formed at any angle including about a 45 degree angle relative to a face of the outer section.

7. The blade of claim 1, wherein the outer section and the inner section are integrally formed from a same piece of material.

8. The blade of claim 1, wherein the inner section comprises a center hub that extends beyond the non-contact shoulder to form the outer section, and wherein the inner section further comprises a first plate disposed on a first face of the center hub and a second plate disposed on an opposite face of the center hub, each of the first and second plates terminating at the non-contact shoulder, and the center hub, the first plate and the second plate are joined together by any suitable method including welding, gluing, soldering or other adhesive agents.

9. The blade of claim 1, wherein the cutting portion has a third thickness, the third thickness being greater than the second thickness and approximately equal to or less than the first thickness.

10. The blade of claim 1, wherein the non-contact shoulder is separated from a distal end of the cutting portion by a distance greater than a cutting depth of the blade.

11. The blade of claim 1, wherein the blade further comprises slots extending radially inwardly from a periphery of the blade to separate the cutting portion into segments.

12. The blade of claim 1, wherein the non-contact shoulder is approximately equal to or greater in diameter than the diameter of a blade flange of the saw assembly, the blade flange being approximately ¼ of the blade diameter.

13. A saw assembly comprising;
a motor; and
a saw blade for rotating about an axis to cut thin control joints of about 2 mm or less in green concrete responsive to operation of the motor, the blade comprising:
a main body comprising an inner section and an outer section, the inner section having a first thickness in an axial direction that is greater than a second thickness of the outer section; and
a cutting portion comprising a diamond-metal matrix joined to the outer section to cut a material responsive to rotation of the blade,
wherein the inner section extends radially outwardly from a center of the blade to a non-contact shoulder at the first thickness to transition to the outer section at the second thickness, the outer section extending radially outwardly to an outer diameter of the main body.

14. The saw assembly of claim 13, wherein the inner section comprises a steel core having the first thickness of about 2 mm to about 20 mm.

15. The saw assembly of claim 13, wherein the first thickness is up to about ten times larger than the second thickness.

16. The saw assembly of claim 13, wherein the second thickness is less than about 2 mm.

17. The saw assembly of claim 13, wherein the non-contact shoulder is formed at a 90 degree angle relative to a face of the outer section.

18. The saw assembly of claim 13, wherein the non-contact shoulder is formed at any angle including about a 45 degree angle relative to a face of the outer section.

19. The saw assembly of claim 13, wherein the outer section and the inner section are integrally formed from a same piece of material.

20. The saw assembly of claim 13, wherein the inner section comprises a center hub that extends beyond the non-contact shoulder to form the outer section, and wherein the inner section further comprises a first plate disposed on a first face of the center hub and a second plate disposed on an opposite face of the center hub, each of the first and second plates terminating at the non-contact shoulder, and the center hub, the first plate and the second plate are joined together by any suitable method including welding, gluing, soldering or other adhesive agents.
